(19) United States
(12) Patent Application Publication
(10) Pub. No.: US 2026/0107359 A1
(43) Pub. Date: Apr. 16, 2026

(54) A LED MODULE FOR PROVIDING UNIFORM LIGHT

(71) Applicant: SIGNIFY HOLDING B.V., EINDHOVEN (NL)

(72) Inventors: HANG LI, SHANGHAI (CN); CHUAN LIANG, JIANG SU (CN); JUN LU, SHANGHAI (CN); WEIHUA MIAO, SHANGHAI (CN); JUNWEN ZHAN, SHANGHAI (CN); ZHENGYU WANG, SHANGHAI (CN)

(21) Appl. No.: 19/115,349

(22) PCT Filed: Sep. 20, 2023
(86) PCT No.: PCT/EP2023/075911

§ 371 Date: Mar. 26, 2025

(30) Foreign Application Priority Data
Sep. 30, 2022 (WO) PCT/CN2022/123518
Nov. 29, 2022 (EP) 22210057.0

(51) Int. Cl. H05B 45/46

(52) U.S. Cl. CPC H05B 45/46

(57) ABSTRACT

It is proposed LED modules for providing uniform light, each module being connected with one other LED module to form a string with a driver side to be connected to a driver and an opposing side, said LED module extends along a length of the LED module, comprising a LED lighting arrangement (D1 to D9); a first interconnection pair (X1, X5) and a first wire (40) connecting the first interconnection pair (X1, X5), across the length of the LED module, adapted to couple to a first output (+) of the driver and to a first interconnection pair (X1, X5) of the other LED module; a second interconnection pair (X4, X8) and a second wire (42) connecting the second interconnection pair (X4, X8), across the length of the LED module, adapted to couple to a second interconnection pair (X4, X5) of the other LED module and a second output (−) of the driver; and a third interconnection pair (X2, X6) and a third wire (44) connecting the third interconnection pair (X2, X6), across the length of the LED module and adapted to couple to a third interconnection pair (X2, X6) of the other LED module; wherein the LED lighting unit (D1 to D9) and one of the first and second wire (40, 42) are connected, and said LED module further comprises a selection circuit adapted to select, according to an operation condition, the LED lighting arrangement connected to said third interconnection pair (X2, X6) of the other LED module, thereby each LED module in the string being coupled to the driver via the other and remaining LED modules till the opposing side; or to the other one of the first and second wire (40, 42) within said LED module thereby each LED module being coupled to the driver without via the other or remaining LED modules till the opposing side.

### FIELD OF THE INVENTION

The present invention relates to the field of LED module to be connected together.

### BACKGROUND OF THE INVENTION

For office or marketplace application, a long/linear luminaire is often needed. The length of luminaire is configured from 8 ft to 16 ft or even longer. The LED module, however, is not likely to be manufactured as a single piece in a length of 8 ft to 16 ft, because a LED module of this length as a single piece is hard to manufacture, stock, transport as well as install. The LED module is often made into a LED module subassembly with a length of 2 ft or 1 ft, and multiple LED subassemblies are connected together to achieve the required length.

For the electrical connection of the multiple LED module subassemblies, daisy chain connection between boards is a normal approach, as FIG. 1 indicates. Daisy chain is a wiring scheme in which multiple devices are wired together in sequence or in a ring, similar to a garland of daisy flower. More specifically, the LED module subassembly #1 to #N each has a pair of positive interfaces and a pair of negative interfaces. One interface of the pair of positive interfaces couples to the positive output of the driver, either directly or via the positive interface of a previous LED module subassembly, and the other interface of the pair of positive interfaces couples to one interface of the pair of positive interfaces of a next LED module subassembly. Similarly, one interface of the pair of negative interfaces couples to the negative output of the driver, either directly or via the negative interface of a previous LED module subassembly, and the other interface of the pair of negative interfaces couples to one interface of the pair of negative interfaces of a next LED module subassembly. Within each LED module subassembly, a positive wire connects the pair of positive interfaces and a negative wire connects the pair of negative interfaces. The LED arrangement is between the positive wire and the negative wire. The two interfaces in each pair of interfaces locate at the opposing side of the LED module subassembly and the respective wires also extend along the length of the LED module subassembly.

In real product, however, since the LED module subassembly is a long linear structure, the resistance of the wire in each LED module assembly should not be neglected and needs to be taken into account. FIG. 2 shows the equivalent circuit with the resistor R at the interconnection between two LED module subassemblies, wherein the resistor R indicates the resistance of the wire of the LED module subassembly upstream of the interconnection. Arrow line I₁ indicates the current through the first LED module subassembly #1, and arrow line I_{N} indicates the current through the last LED module subassembly #N. The output of the LED driver is normally a voltage source. For the last LED module subassembly #N, the extra resistances of the wires are in series with the last LED module subassembly thus its current would be less than the current through the first LED module subassembly #1. FIG. 3 schematically shows the brightness of the LED module subassemblies, decreasing from the driver side connected to the driver to the opposing side farthest away from the driver.

CN209511674U discloses a LED light strip capable of providing a uniform light output from head to tail of the light strip. The LED light strip in this prior art is a standalone product able to be cuttable, not to be assembled with any other LED light strip. CN109982487A discloses a similar technology.

WO2018100502A1 discloses a lighting system formed by an assembly of multiple lighting modules.

### SUMMARY OF THE INVENTION

Although the prior art CN209511674U and CN109982487A can achieve a uniform light output along the whole length of the LED light strip, it has an inevitable power loss due to the addition of the wire resistance. Since energy efficiency becomes more and more important, it is still needed to provide an energy efficient product.

The invention is defined by the claims.

A basic idea of the invention is providing alternations of using the additional wire resistance to provide the uniform lumen output and not using the additional wire resistance. The later case can be activated according to an operation condition. In one example, the operation condition could relate to energy/power efficiency. More specifically, if energy efficiency is required and the non-uniform lumen output can be tolerated, the additional wire resistance can be bypassed/not used; if uniform lumen output is required and the energy/power loss can be tolerated, the additional wire resistance can be used. This provides a more adaptive/flexible technique.

In a first aspect of the invention, it is provided an LED module adapted to be connected with one other LED module to form a string with a driver side to be connected to a driver and an opposing side, said LED module extends along a length of the LED module, comprising
a LED lighting arrangement;
a first interconnection pair and a first wire connecting the first interconnection pair, across the length of the LED module, adapted to couple to a first output of the driver and to a first interconnection pair of the other LED module;
a second interconnection pair and a second wire connecting the second interconnection pair, across the length of the LED module, adapted to couple to a second interconnection pair of the other LED module and a second output of the driver; and
a third interconnection pair and a third wire connecting the third interconnection pair, across the length of the LED module and adapted to couple to a third interconnection pair of the other LED module;
   wherein the LED lighting unit and one of the first and second wire are connected, and said LED module further comprises a selection circuit adapted to select, according to an operation condition, the LED lighting arrangement connected to said third interconnection pair of the other LED module, thereby each LED module in the string being coupled to the driver via the other and remaining LED modules at the opposing side; or to the other one of the first and second wire within said LED module thereby each LED module being coupled to the driver without via the other or remaining LED modules till the opposing side.

This aspect of the invention proposes LED module that are connectable to and cooperative with each other to make each LED module connect to the driver via other LED module and via the connection at the last LED module. In this way, the wire length between the driver and each LED module is substantially same, thus the wire resistance for each LED module is the same and the light output of each LED module is the same and uniform. Even more, it is provided a flexibility to set the LED module either in the proposed new configuration to provide uniform light output at cost of efficiency or in the traditional configuration to provide high efficiency at cost of light output uniformity, especially when the requirement for the luminaire is different.

By connecting the LED lighting arrangement directly to the other one of the first and second wire within said LED module, the current goes to the driver directly without going to other LED module and this adapt the LED module to suit an application wherein the light output uniform can be accepted but power loss on the wire of the other LED module is strictly limited. This embodiment provides a versatile LED module which can meet different requirements by flexibly re-configuring the LED module in real time.

In one embodiment, the LED module is a LED module subassembly, and said interconnection pairs are interface pairs. If said LED module subassembly is the last one at the opposing side, the LED module subassembly is adapted to form a connection between the third wire and the other one of the first and second wire, thereby each LED module subassembly in the string being coupled to the driver via the other LED and remaining LED module subassemblies till the opposing side and the connection at the opposing side

In one embodiment, the third wire is adapted to couple the LED lighting unit from the first wire to the third wire, and if said LED module is the last one at the opposing side the LED module is adapted to form the connection from the third wire to the second wire.

In this embodiment, the third wire and the second wire of the other LED modules are used for balancing the difference of the wire length between the LED module and the driver via the first wire and the second wire.

In an alternative embodiment, the third wire is adapted to couple the LED lighting unit from the third wire to the second wire and if said LED module is the last one at the opposing side the LED module is adapted to form the connection from the first wire to the third wire.

In this embodiment, the third wire and the first wire of the other LED modules are used for balancing the difference of the wire length between the LED module and the driver via the first wire and the second wire.

In one embodiment, the first interconnection pair is adapted to couple to a positive voltage output of the driver and the second interconnection pair is adapted to couple to a negative voltage output of the driver.

In this embodiment, the first wire and first interconnection pair are the current flowing-in end and the second wire and the second interconnection pair are the current flowing-out end.

In one embodiment, the LED module further comprises a jumper terminal between the third interconnection pair and one of the first and second interconnection pair, wherein said jumper terminal is adapted to receive a jumper to form said connection between the third wire and the other one of the first and second wire.

This embodiment provides a manual way for forming the connection. The installer or maintainer for the LED modules can install the connection at the last LED module conveniently.

In an alternative embodiment, the connection is formed in an electrical and automatic way. More specifically, the LED module further comprises a circuit connected the third wire and the other one of the first and second wire, said circuit comprising: a detector adapted to detect whether said LED module is the last LED module at the opposing side; and a first switch adapted to be triggered by said detector to electrically connect the third wire and the other one of the first and second wire.

In this embodiment, it does not need the manual action from human and is human-error proof.

In a further embodiment, a specific implementation for the detector is provided: said LED module comprises a fourth terminal connected to a reference voltage, and said detector is adapted to be connect to a fourth terminal of the other module or be float if said LED module is the last LED module at the opposing side, wherein said detector is adapted to determine whether said LED module is the last LED module at the opposing side by detecting whether the voltage at the detector is corresponding to the reference voltage.

In this embodiment, a fourth interconnection pair is used for differentiating the last LED module from others, and this makes the detector simple to implement. It should be noted that there are other implementations for the detector.

Further, the inventors find that the non-uniform light output is not significant in high brightness mode with a high operation current whereas the power loss in the high brightness mode is substantial, thus in an improved embodiment, the re-configuration is depending on the high/low brightness of the luminaire. More specifically, said selection circuit comprises a current detection circuit adapted to detect a current through the LED lighting arrangement as the operation condition; and a second switch connected between the LED lighting arrangement and the other one of the first and second wire, said second switch is adapted to be triggered close and connect the LED lighting arrangement and the other one of the first and second wire within the LED module if the detected current is higher than a threshold and open to keep the LED lighting arrangement connected to said third interconnection pair of the other LED module if the detected current is less than the threshold.

In this embodiment, the LED module can be automatically adapted according to the operating current, achieving neglectable output difference as well as providing high efficiency in high brightness mode.

In one further embodiment, said LED lighting arrangement comprises a plurality of LED units distributed along the length of the LED module.

This embodiment provides a linear light emission.

In a second aspect of the invention, it is provided a LED lighting assembly comprising a plurality of the LED modules as mentioned above which are adapted to be connected in a daisy chain.

In a third aspect of the invention, it is provided a LED luminaire comprising the LED lighting assembly according to the second aspect and a driver adapted to connect and provide power to the LED modules via the first interconnection pair and the second interconnection pair.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a prior topology of LED module subassemblies connected in a daisy chain;

FIG. 2 shows an equivalent circuit of the prior topology of FIG. 1;

FIG. 3 schematically shows the brightness difference of the LED module subassemblies in the prior topology of FIG. 1;

FIG. 4 shows a LED module subassembly, according to a basic embodiment of the invention;

FIG. 5 shows an equivalent topology of LED module subassemblies of claim 4 assembled in a daisy chain;

FIG. 6 shows a LED module subassembly, according to an improved embodiment of the invention;

FIG. 7 shows a plurality of LED module subassemblies of FIG. 6 assembled in a daisy chain;

FIG. 8 shows a LED module subassembly, according to another improved embodiment of the invention;

FIG. 9 shows a plurality of LED module subassemblies of FIG. 8 assembled in a daisy chain;

FIG. 10 shows a LED module subassembly, according to another embodiment of the invention; and

FIG. 11 shows a plurality of LED module subassemblies of FIG. 10 assembled in a daisy chain.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

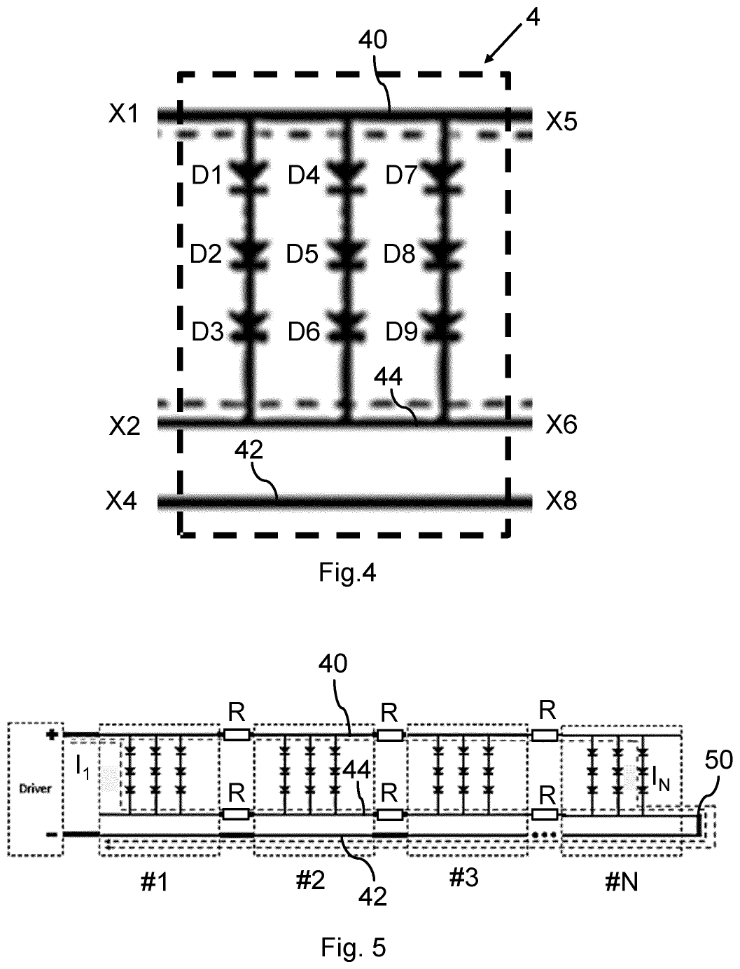

FIG. 4 shows a LED module subassembly, according to a basic embodiment of the invention. The LED module subassembly is adapted to be assembled with one other LED module subassembly to form a string with a driver side to be connected to a driver and an opposing side, such as shown in FIG. 5. The LED module subassembly extends along a length of the LED module subassembly, and comprises
a LED lighting arrangement D1 to D9, wherein FIG. 4 shows the LED lighting arrangement is a 3×3 LED matrix (3 parallel branches of 3 series connected LED units), and it should be understood that any other arrangement of LED units is applicable;
a first interface pair X1, X5 at two facing sides of the subassembly and a first wire 40 connecting the first interface pair X1, X5, the first wire is across the length of the LED module subassembly; as shown in later FIG. 5, the first interface pair is adapted to couple to a first output + of the driver and to a first interface pair X1, X5 of the other LED module subassembly;
a second interface pair X4, X8 at two facing sides of the subassembly and a second wire 42 connecting the second interface pair X4, X8 and across the length of the LED module subassembly; as shown in later FIG. 5, the second interface pair is adapted to couple to a second interface pair X4, X5 of the other LED module subassembly and a second output
of the driver; and
   a third interface pair X2, X6 at two facing sides of the subassembly and a third wire 44 connecting the third interface pair X2, X6, across the length of the LED module subassembly and adapted to couple to a third interface pair X2, X6 of the other LED module subassembly.

In the embodiment of FIGS. 4 and 5, the third wire 44 is adapted to couple the LED lighting unit D1 to D9 and the first wire 40, in other words, the LED lighting unit D1 to D9 is between the first wire 40 and the third wire 44.

Further as shown in FIG. 5, for the last LED module subassembly #N at the opposing side of the string away from the driver, the LED module subassembly #N is adapted to form a connection 50 between the third wire 44 and the second wire 42.

In this manner, each LED module subassembly in the string is coupled to the driver via other LED module subassemblies and the connection 50 at the last one LED module subassembly at the opposing side.

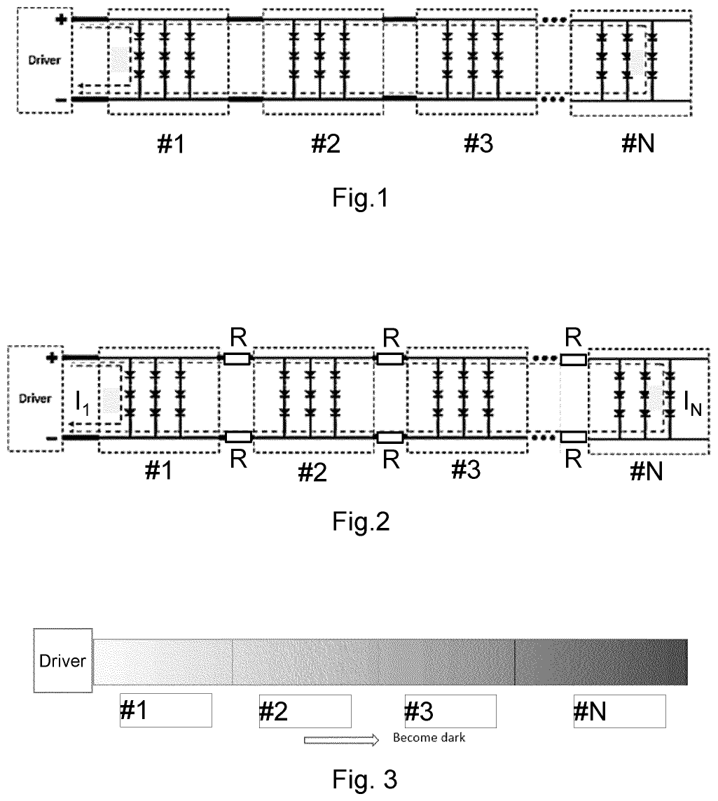

More specifically, for the first LED module subassembly #1, the current flows out of the positive + output of the driver and into the LED arrangements, and flows out of the first LED module subassembly #1 through the third wire 44, instead of through the second wire 42 as in the prior art in FIG. 1. The current then goes to the rest of LED module subassemblies via the third interface pair X2, X6 and corresponding third wires 44 until the last LED module subassembly #N. Then the current goes to the second interface pair X2, X6 of the last LED module subassembly #N via the connection 50, and returns to the negative output − of the driver via the second interface pairs and second wires of all the LED module subassemblies. The current flow is shown by the arrow line I₁. In this path, there are three wire resistances R of three third wires 44, among other wire resistance.

And for the last LED module subassembly #N, the current flows out of the positive + output of the driver, and flows through the first interface pair X1, X5 and first wire 40 of previous LED module subassemblies, and flow into the last LED module subassembly #N and the LED arrangement. The current then flows to the second interface pair X6, X8 of the last LED module subassembly #N via the connection 50, and returns to the negative output − of the driver via the second interface pairs X6, X8 and second wires 42 of all the LED module subassemblies. The current flow is shown by the arrow line I_{N}. In this path, there are also three wire resistances R of the first wires 40, among other wire resistance.

Notably, the three wire resistances R of the first wires 40 for the last subassembly #N equals to the three wire resistances R of the third wires 44 for the first subassembly #1. Also, both the first subassembly and the last subassembly connect back to the negative output of the driver via the same length of all the second wires 42 of all subassemblies.

It can be seen that the total wire resistances are the same for the first LED module subassembly #1 and the last LED module subassembly #N. Based on similar principle, those skilled in the art can understand that the wire resistance is also the same for each LED module subassembly such as #2 and #3 between the first and the last LED module subassemblies. Thus each LED module subassembly is connected with a same wire resistance to the same voltage output of the driver, and each LED module subassembly emits uniform/same light.

For the connection 50, the present application provides two embodiments, though it is not limited as such.

In a first embodiment, the connection is provided manually. Each LED module subassembly comprises a jumper terminal between one third interface X6 and one second interface X8, wherein said jumper terminal is adapted to receive a jumper to form said connection 50 between the third wire and the second wire. The jumper can be inserted to the last LED module subassembly by an installer installing or maintaining the LED module subassemblies.

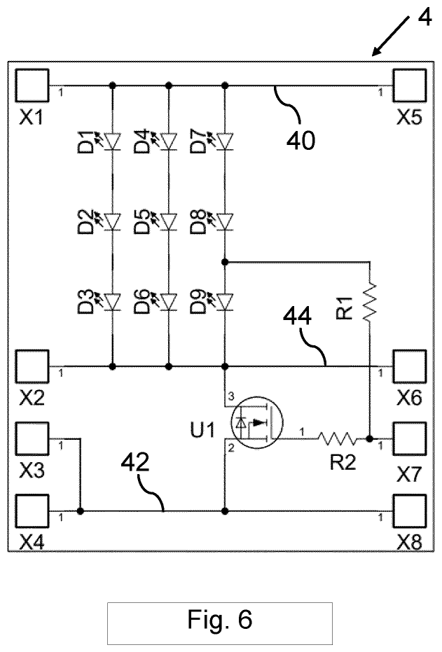

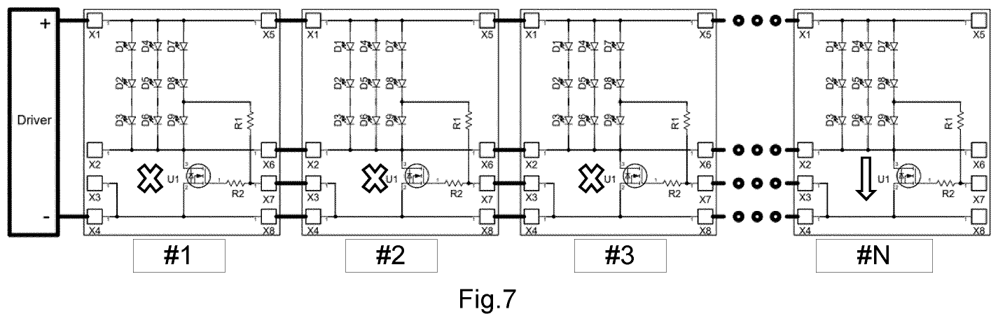

In a second embodiment, the connection is provided electrically and automatically. As shown in FIGS. 6 and 7, each LED module subassembly comprises a circuit connected the third wire 44 and the second wire 42, and said circuit comprising:
a detector X7 adapted to detect whether said LED module subassembly is the last LED module subassembly at the opposing side; and
a first switch U1 adapted to be triggered by said detector to electrically connect the third wire 44 and the second wire 42.

There are many implementations for the detector. The present application gives one example in FIGS. 6 and 7. The first switch U1 is a MOSFET. A gate of the MOSFET U1 is connected to the first wire 40 via two resistors R1 and R2, and the resistors R1 and R2 can drive the MOSFET. An interconnection point between the resistors R1 and R2 is provided with a fourth interface X7. The LED module subassembly has another fourth interface X3 pulled to a reference voltage, such as connected to the negative/second interface X4.

As shown in FIG. 7, when one LED module subassembly is not the last one and is connected to a downstream LED module subassembly, the fourth interface X7 is connected to a fourth interface X3 of the downstream LED module subassembly and is pulled to the second interface X4 which is effectively zero voltage/negative output of the driver, thus the gate of the first switch U1 is pulled to zero, and the first switch U1 is not driven and is open. Therefore, the third wire 44 of this LED module subassembly is not connected to the second wire 42.

When one LED module subassembly #N is the last one, the fourth interface X7 is float without connecting to any point and thus not pulled to the second interface X4 which is effectively zero voltage/negative output of the driver. Thus the gate of the first switch U1 is pulled up by the resistors R1 with respect to the first wire 40, and the switch U1 is driven to be close. Therefore, the third wire 44 of this LED module subassembly #N is connected to the second wire 42 and forms the connection 50.

The inventors also notice that, compared with the prior art in FIGS. 1 and 2, some additional wire resistance is added especially to the LED module subassemblies at or near the driver side of the string close to the driver. Thus there is some power loss caused by those additional wire resistance. Via experiments and field tests, the inventors find that the un-uniform light output is somewhat tolerable/neglectable when the linear luminaire is set to work in a high brightness mode. This is because the output current is quite high in the high brightness mode, and the current difference caused by the different wire resistance only takes a small portion in the high output current. Whereas in the low brightness mode, the output current is small, and the current difference caused by the different wire resistance only takes a substantial portion in the low output current thus the un-uniformity is unneglectable. However in the low brightness, the power loss is often acceptable. Thus the improved embodiment of the invention proposes that in case that the un-uniform light output can be accepted, in order to reduce the power loss, using a flexible selection circuit to switch the LED module subassembly from the mode of routing the current to the rest LED module subassemblies as mentioned above to a mode of routing the current to the driver directly similar as the prior art in FIGS. 1 and 2. In case that the un-uniform light output can not be accepted but the power loss can be accepted such as in the low birghtness mode, the selection circuit keeps the LED module subassembly in the mode of routing the current to the rest LED module subassemblies as mentioned above.

More specifically, said LED module subassembly further comprises a selection circuit adapted to select, according to an operation condition, the LED lighting arrangement coupled
to said third interface pair of the other LED module subassembly thereby via the other LED module subassembly and via the connection at the last one LED module subassembly at the opposing side. or
to the other one of the first and second wire within said LED module subassembly thereby each LED module subassembly being coupled to the driver without via the other LED module subassembly and the connection at the last one LED module subassembly at the opposing side.

In one embodiment, the selection is depending on the driving current provided to the LED module subassembly. And said selection circuit comprises
a current detection circuit adapted to detect a current through the LED lighting arrangement as the operation condition; and
a second switch between the LED lighting arrangement and the other one of the first and second wire, said second switch is adapted to be triggered close and connect the LED lighting arrangement and the other one of the first and second wire within the LED module subassembly if the detected current is higher than a threshold and open if the detected current is less than the threshold.

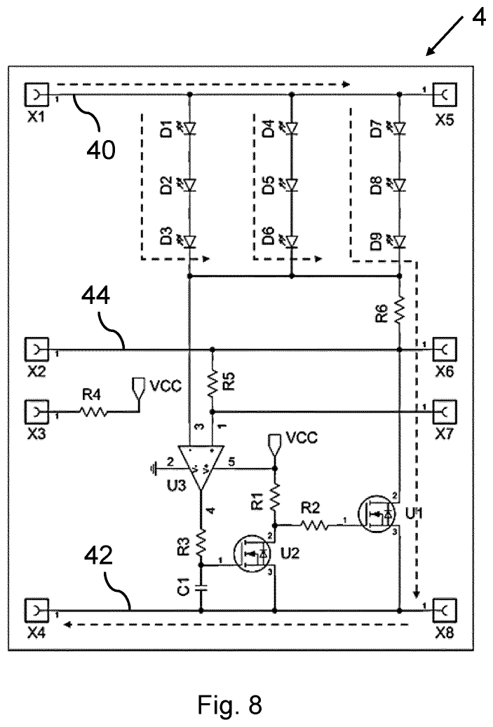

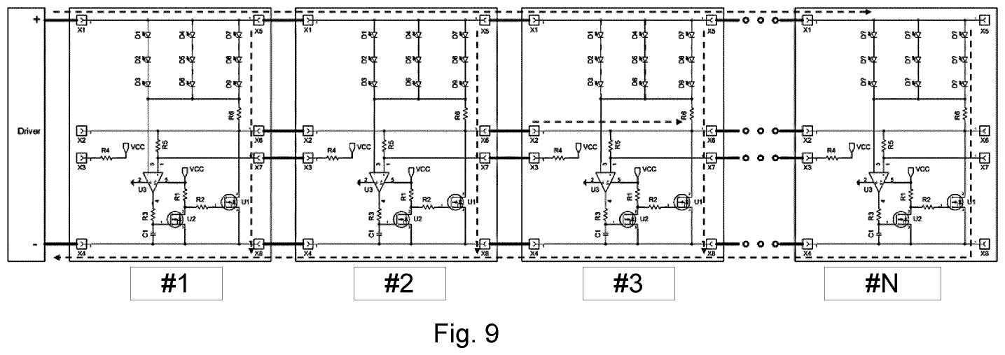

As shown in FIG. 8, the current detection circuit comprises a resistor R6 in series with the LED lighting arrangement D1 to D9, a comparator U3, and a MOSFET U2. The second switch is also implemented by the MOSFET U1. A negative input of the comparator U3 is connected to the resistor R6, and a positive input of the comparator U3 is coupled to interface X7 which is coupled to the interface X3 of the next LED module subassembly and to a reference voltage VCC. The reference voltage VCC sets the threshold mentioned above.

When the current through the LED lighting arrangement, sensed by the resistor R6, is larger than the reference voltage VCC, the comparator U3 would output a negative or zero voltage to the gate of the MOSFET U2 and the MOSFET U2 is off. The VCC drives the MOSFET U1 via the resistors R1 and R2 to turn the MOSFET U1 on, so that the LED lighting arrangement D1 to D9 is connected to the second wire 42 directly within the LED module subassembly. Please note that although the LED lighting arrangement D1 to D9 is still connected to the third interface pair X6, the impedance of third interface pair X2, X6 and third wire 33 in the later LED module subassemblies is higher than the resistance of the second wire 42, thus there is no current flowing to the later LED module subassemblies but the current would flow to the second wire 42 to return to the driver. In a further embodiment, a switch can be added at the third interface pair X6 to isolate the LED lighting arrangement D1 to D9 from the third interface pair X6.

When the current through the LED lighting arrangement, sensed by the resistor R6, is smaller than the reference voltage VCC, the comparator U3 would output a positive voltage to the gate of the MOSFET U2 and the MOSFET U2 is on. The gate of the MOSFET U1 is pulled to low to turn the MOSFET U1 off, so that the LED lighting arrangement D1 to D9 is isolated from the second wire 42 within the LED module subassembly and is electrically connected to the later LED module subassembly via the third interface pair X6. The whole luminaire works in a way similar as FIGS. 4 and 5.

It should be noted that the selection can also depending on other operation condition such as real time electricity tariff or an efficiency request: if the electricity tariff is high or the system is required to work in high efficiency mode, the power loss is better low thus the selection circuit selects the LED module subassembly work in traditional mode with high efficiency but with less uniformity. If the electricity tariff is low or the system can work in less efficiency and high light output performance mode, the power loss can be accepted, thus the selection circuit selects the LED module subassembly work in the proposed new mode with high uniformity.

The present application also proposes a LED lighting assembly comprising a plurality of the LED module subassemblies which are assembled together, and proposes a LED lighting luminaire comprising the LED lighting assembly and a driver for driving the LED module subassemblies.

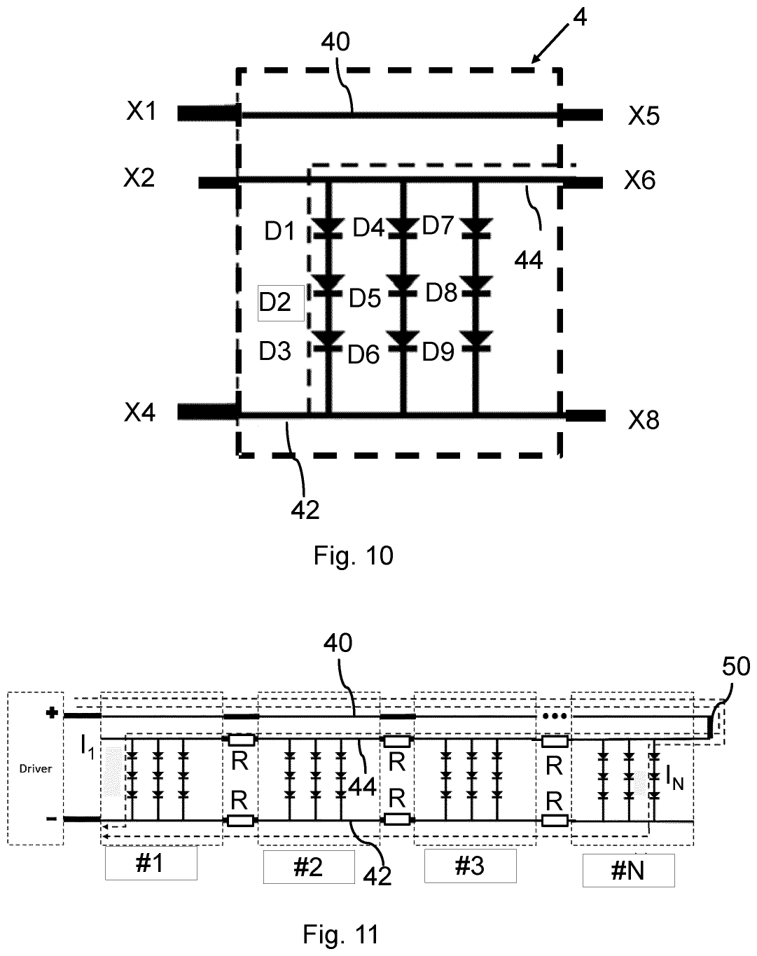

In the above embodiments, the third wire 44 is connected to the cathode of the LED lighting arrangement in each LED module subassemblies and is connected to the second wire 42 at the last LED module subassembly. This is just one example. In an alternative embodiment as shown in FIGS. 10 and 11, the third wire 44 is adapted to couple the LED lighting arrangement from the third wire 44 to the second wire 42, in other words, the LED lighting unit is coupled to the third wire 44 at the anode and to the second wire 22 at the cathode. As shown in FIG. 11, the third interface pair X6 of one LED module subassembly is connected to a third interface pair X2 of the next LED module subassembly, and the third interface pair X6 of the last LED module subassembly is connected to the first interface pair X5 of the last LED module subassembly to form a connection 50. It can be seen that this embodiment is effectively swapping the positive power wire and the negative power wire of the embodiment in FIGS. 4 and 5.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. An LED module adapted to be connected with one other LED module to form a string with a driver side to be connected to a driver and an opposing side, said LED module extends along a length of the LED module, comprising
a LED lighting arrangement;
a first interconnection pair and a first wire connecting the first interconnection pair, across the length of the LED module, adapted to couple to a first output of the driver and to a first interconnection pair of the other LED module;
a second interconnection pair and a second wire connecting the second interconnection pair, across the length of the LED module, adapted to couple to a second interconnection pair of the other LED module and a second output of the driver; and
a third interconnection pair and a third wire connecting the third interconnection pair, across the length of the LED module and adapted to couple to a third interconnection pair of the other LED module;
wherein the LED lighting unit and one of the first and second wire are connected, and said LED module further comprises a selection circuit adapted to select, according to an operation condition, the LED lighting arrangement connected,
to said third interconnection pair of the other LED module, thereby each LED module in the string being coupled to the driver via the other and remaining LED modules till the opposing side; or
to the other one of the first and second wire within said LED module thereby each LED module being coupled to the driver without via the other or remaining LED modules till the opposing side.

2. The LED module according to claim 1, wherein said LED module is a LED module subassembly and said interconnection pairs are interface pairs,
if said LED module subassembly is the last one at the opposing side, the LED module subassembly is adapted to form a connection between the third wire and the other one of the first and second wire, thereby each LED module subassembly in the string being coupled to the driver via the other LED and remaining LED module subassemblies till the opposing side and the connection at the opposing side.

3. The LED module according to claim 2, further comprising a jumper terminal between the third interface pair and one of the first and second interface pair, wherein said jumper terminal is adapted to receive a jumper to form said connection between the third wire and the other one of the first and second wire.

4. The LED module according to claim 1, further comprising a circuit connected the third wire and the other one of the first and second wire, said circuit comprising:
a detector adapted to detect whether said LED module is the last LED module at the opposing side; and
a first switch adapted to be triggered by said detector to electrically connect the third wire and the other one of the first and second wire.

5. The LED module according to claim 4, wherein said LED module comprises a fourth terminal connected to a reference voltage, and said detector is adapted to be connect to a fourth terminal of the other module or be float if said LED module is the last LED module at the opposing side,
wherein said detector is adapted to determine whether said LED module is the last LED module at the opposing side by detecting whether the voltage at the detector is corresponding to the reference voltage.

6. The LED module according to claim 1, wherein said selection circuit comprises:
a current detection circuit adapted to detect a current through the LED lighting arrangement as the operation condition; and
a second switch connected between the LED lighting arrangement and the other one of the first and second wire, said second switch is adapted to be triggered close and connect the LED lighting arrangement and the other one of the first and second wire within the LED module if the detected current is higher than a threshold and open to keep the LED lighting arrangement connected to said third interface pair of the other LED module if the detected current is less than the threshold.

7. The LED module according to claim 1, wherein the third wire is adapted to couple the LED lighting arrangement from the first wire to the third wire, and if said LED module is the last one at the opposing side the LED module is adapted to form the connection from the third wire to the second wire.

8. The LED module according to claim 1, wherein the third wire is adapted to couple the LED lighting arrangement from the third wire to the second wire and if said LED module is the last one at the opposing side the LED module is adapted to form the connection from the first wire to the third wire.

9. The LED module according to claim 1, wherein the first interface pair is adapted to couple to a positive voltage output of the driver and the second interface pair is adapted to couple to a negative voltage output of the driver.

10. The LED module according to claim 1, wherein said LED lighting arrangement comprises a plurality of LED units distributed along the length of the LED module.

11. A LED lighting assembly comprising a plurality of the LED modules according to claim 1 which are adapted to be connected in a daisy chain.

12. A LED luminaire comprising the LED lighting assembly according to claim 11 and a driver adapted to connect and provide power to the LED modules via the first interconnection pair and the second interconnection pair.

13. A LED lighting system comprising a driver, and a plurality of LED modules connected sequentially to form a string with a driver side close to the driver and an opposing side, each LED module extends along a length of the LED lighting system, each LED module comprising a LED lighting arrangement;
the LED lighting system further comprising
an anode bus line and a cathode bus line extending along the length of the LED lighting system, wherein the LED lighting arrangements are placed across the anode bus line and the cathode bus line along the length of the LED lighting system
a return line extending along the length of the LED lighting system; and
a selection circuit adapted to select, according to an operation condition,
the return line and one of the anode bus line and the cathode bus line connect to the driver at the driver side, and the other one of the anode bus line and the cathode bus line connects to the return line at the opposing side, thereby each LED module in the string being coupled to the driver via the other one of the anode bus line and the cathode bus line till the opposing side and the return line; or
both of the anode bus line and the cathode bus line to the driver at the driver side, thereby each LED module in the string being coupled to the driver without via any of the bus lines till the opposing side and the return line.

14. A LED lighting system according to claim 13, wherein the selection circuit is adapted to select according to any one of the below as the operation condition:
a current in the LED lighting system;
a light output performance; and
an efficiency request.

15. An LED module subassembly adapted to be assembled with one other LED module subassembly to form a string with a start side to be connected to a driver and an opposing side, said LED module subassembly extends along a length of the LED module subassembly, comprising
a LED lighting arrangement;
a first interconnection pair and a first wire connecting the first interconnection pair, across the length of the LED module subassembly, adapted to couple to a first output of the driver and to a first interconnection pair of the other LED module subassembly;
a second interconnection pair and a second wire connecting the second interconnection pair, across the length of the LED module subassembly, adapted to couple to a second interconnection pair of the other LED module subassembly and a second output of the driver; and
a third interconnection pair and a third wire connecting the third interconnection pair, across the length of the LED module subassembly and adapted to couple to a third inter interconnection face pair of the other LED module subassembly;
wherein the third wire is adapted to couple the LED lighting unit and one of the first and second wire, and if said LED module subassembly is the last one at the opposing side the LED module subassembly is adapted to form a connection between the third wire and the other one of the first and second wire thereby each LED module subassembly in the string being coupled to the driver via the other LED module subassembly and the connection at the last one LED module subassembly at the opposing side;
further comprising a circuit connected the third wire and the other one of the first and second wire, said circuit comprising:
a detector adapted to detect whether said LED module subassembly is the last LED module subassembly at the opposing side; and
a first switch adapted to be triggered by said detector to electrically connect the third wire and the other one of the first and second wire.

16. The LED module subassembly according to claim 15, wherein said LED module comprises a fourth terminal connected to a reference voltage, and said detector is adapted to be connect to a fourth terminal of the other module or be float if said LED module is the last LED module at the opposing side,
wherein said detector is adapted to determine whether said LED module is the last LED module at the opposing side by detecting whether the voltage at the detector is corresponding to the reference voltage.

17. A LED lighting assembly comprising a plurality of the LED modules according to claim 15 which are adapted to be connected in a daisy chain.

18. A LED luminaire comprising the LED lighting assembly according to claim 17 and a driver adapted to connect and provide power to the LED modules via the first interconnection pair and the second interconnection pair.
